(19) United States
(12) Patent Application Publication
(10) Pub. No.: US 2026/0350445 A1
(43) Pub. Date: Nov. 5, 2026

(54) QUANTUM COMPUTING TASK PRELOADING

(71) Applicant: International Business Machines Corporation, Armonk, NY (US)

(72) Inventors: Brittany McPeek, Rochester, MN (US); Paul Schardt, Rochester, MN (US); Timothy Lindquist, Rochester, MN (US); Andrew Wack, Millbrook, NY (US); Einar Lueck, Filderstadt (DE)

(21) Appl. No.: 18/654,064

(22) Filed: May 3, 2024

(51) Int. Cl. G06N 10/20

(52) U.S. Cl. CPC G06N 10/20

(57) ABSTRACT

Systems and techniques that facilitate preloading of quantum computing tasks are provided. For example, one or more embodiments described herein can comprise a system, which can comprise quantum computer, a memory that can store computer executable components and a processor, operably coupled to the memory that can execute the computer executable components stored in memory. The computer executable components can comprise a task comparison component that identifies one or more commands shared between the first quantum computing task and a second quantum computing task and prevents redundant loading of the one or more commands shared between the first quantum computing task and the second quantum computing task; and a task management component that loads, during execution of the first quantum computing task, commands for the second quantum computing task that are not shared by the first quantum computing task into control electronics of the quantum computer.

### BACKGROUND

The subject disclosure relates to preloading of tasks for execution in quantum computers, and more specifically to preloading of a quantum computing task during execution of a prior quantum computing task.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate preloading of quantum tasks for quantum computers are provided.

According to an embodiment, a system can comprise a quantum computer that executes commands for a first quantum computing task and a processor that executes computer executable components stored in memory. The computer executable components can comprise a task comparison component that identifies one or more commands shared between the first quantum computing task and a second quantum computing task and prevents redundant loading of the one or more commands shared between the first quantum computing task and the second quantum computing task; and a task management component that loads, during execution of the first quantum computing task, commands for the second quantum computing task that are not shared by the first quantum computing task into control electronics of the quantum computer. An advantage of such a system is that by loading commands for a second quantum computing task during execution of the first quantum computing task, the amount of downtime between execution of sequential quantum computing tasks is decreased, thereby allowing more tasks to be executed in a defined timeframe.

According to another embodiment, a computer implemented method can comprise executing, by a system operatively coupled to a processor, commands for a first quantum computing task in a quantum computer; identifying, by the system, commands shared between the first quantum computing task and a second quantum computing task; preventing, by the system, redundant loading of the commands shared between the first quantum computing task and the second quantum computing task; and loading, by the system, during execution of the first quantum computing task, commands for the second quantum computing task that are not shared by the first quantum computing task into control electronics of the quantum computer. An advantage of such a method is that by loading commands for a second quantum computing task during execution of the first quantum computing task, the amount of downtime between execution of sequential quantum computing tasks is decreased, thereby allowing more tasks to be executed in a defined timeframe.

According to another embodiment, a computer program product comprising a computer readable storage medium having program instructions embodied therewith, the program instructions executable by a processor to cause the processor to execute, by the processor, commands for a first quantum computing task in a quantum computer; identify, by the processor, commands shared between the first quantum computing task and a second quantum computing task; prevent by the processor, redundant loading of the commands shared between the first quantum computing task and the second quantum computing task; and load, by the processor, during execution of the first quantum computing task, commands for the second quantum computing task that are not shared by the first quantum computing task into control electronics of the quantum computer. An advantage of such a computer program product is that by loading commands for a second quantum computing task during execution of the first quantum computing task, the amount of downtime between execution of sequential quantum computing tasks is decreased, thereby allowing more tasks to be executed in a defined timeframe.

### DESCRIPTION OF THE DRAWINGS

FIG. 1 illustrates a block diagram of an example, non-limiting system that can facilitate preloading of quantum computing tasks in accordance with one or more embodiments described herein.

FIG. 2 illustrates an example of execution of a sequence of quantum computing tasks without preloading.

FIG. 3 illustrates an example of execution of a sequence of quantum computing tasks with preloading in accordance with one or more embodiments described herein.

FIG. 4 illustrates an example of execution of a sequence of quantum computing tasks with preloading of multiple sequential tasks in accordance with one or more embodiments described herein.

FIG. 5 illustrates an example of execution of a sequence of quantum computing tasks with preloading of specific individual buffers in accordance with one or more embodiments described herein.

FIG. 6 illustrates a graph comparing the execution time of quantum systems with and without preloading of future quantum computing tasks in accordance with one or more embodiments described herein.

FIG. 7 illustrates a chart showing the percentage of time saved during execution when employing preloading in accordance with one or more embodiments described herein.

FIG. 8 illustrates a flow diagram of an example, non-limiting, computer implemented method that facilitates preloading of commands for a quantum computing task in accordance with one or more embodiments described herein.

FIG. 9 illustrates a flow diagram of an example, non-limiting, computer implemented method that facilitates preloading of commands for a quantum computing task and prevents redundant loading of commands in accordance with one or more embodiments described herein.

FIG. 10 illustrates a block diagram of an example, non-limiting system that can complete execution of a quantum job in accordance with one or more embodiments described herein.

FIG. 11 illustrates an example, a non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an aspect of the invention, there is provided a system comprising a quantum computer that executes commands for a first quantum computing task, a memory that stores computer executable components and a processor that executes the computer executable components stored in the memory. The computer executable components comprise a task comparison component that identifies one or more commands shared between the first quantum computing task and a second quantum computing task and prevents redundant loading of the one or more commands shared between the first quantum computing task and the second quantum computing task, and a task management component that loads, during execution of the first quantum computing task, commands for the second quantum computing task that are not shared by the first quantum computing task into control electronics of the quantum computer. An advantage of such a system is that by loading commands for a second quantum computing task during execution of the first quantum computing task, the amount of downtime between execution of sequential quantum computing tasks is decreased, thereby allowing more tasks to be executed in a defined timeframe. By allowing more tasks to be executed in a defined timeframe, additional calibration tasks can be performed to ensure that the quantum computer to properly calibrated, thereby improving fidelity of results of executed quantum computing tasks.

In some embodiments of the above-described system, the task management component further manages a reference of data for quantum computing tasks. By managing a reference of data for quantum computing tasks, buffer locations where commands are loaded can be tracked, allowing for better utilization of the memory buffers.

In some embodiments of the above-described system, the reference of data for quantum computing tasks comprises a sequence of buffered quantum computing tasks for loading while a preceding quantum computing task in the sequence of buffered quantum computing tasks is executed. By managing a sequence of buffered quantum computing tasks, the commands for one or more additional quantum computing tasks can be preloaded during execution of a first quantum computing task, thereby decreasing the downtime between execution of sequential quantum computing tasks.

In some embodiments of the above-described system, the loading comprises loading of one or more individual buffers. By loading one or more individual buffers, the differences between the types of commands of the first quantum computing task and the second quantum computing task can be leveraged to allow for a larger number of commands of the second quantum computing task to be loaded during execution of the first quantum computing task.

In some embodiments of the above-described system, the loading comprises loading of one or more partial buffers. The loading of one or more partial buffers allows for better usage of available memory buffers that store commands for the first quantum computing task but still have available space can be utilized to store commands for the second quantum computing task.

In some embodiments of the above-described system, the quantum computer further executes commands for the second quantum computing task, wherein the second quantum computing task is executed using the quantum state produced by the first quantum computing task. By loading commands for the second quantum computing task during execution of the first quantum computing task and then executing the second quantum computing task using the state produced by the first quantum computing task, the quantum state produced by the first quantum computing task can be utilized before quantum decoherence can impact the accuracy of the quantum state.

According to an embodiment of the invention, a computer-implemented method is provided comprising executing, by a system operatively coupled to a processor, commands for a first quantum computing task in a quantum computer, identifying, by the system, commands shared between the first quantum computing task and a second quantum computing task, preventing, by the system, redundant loading of the commands shared between the first quantum computing task and the second quantum computing task, and loading, by the system, during execution of the first quantum computing task, commands for the second quantum computing task that are not shared by the first quantum computing task into control electronics of the quantum computer. An advantage of such a computer implemented method is that by loading commands for a second quantum computing task during execution of the first quantum computing task, the amount of downtime between execution of sequential quantum computing tasks is decreased, thereby allowing more tasks to be executed in a defined timeframe. By allowing more tasks to be executed in a defined timeframe, additional calibration tasks can be performed to ensure that the quantum computer to properly calibrated, thereby improving fidelity of results of executed quantum computing tasks.

In some embodiments of the above-described method, the method can further comprise managing, by the system, a reference of data for quantum computing tasks. By managing a reference of data for quantum computing tasks, buffer locations where commands are loaded can be tracked, allowing for better utilization of the memory buffers.

In some embodiments of the above-described method, the reference of data for quantum computing tasks comprises a sequence of buffered quantum computing tasks for loading while a preceding quantum computing task in the sequence of buffered quantum computing tasks is executed. By managing a sequence of buffered quantum computing tasks, the commands for one or more additional quantum computing tasks can be preloaded during execution of a first quantum computing task, thereby decreasing the downtime between execution of sequential quantum computing tasks.

In some embodiments of the above-described method, the loading comprises loading of one or more individual buffers. By loading one or more individual buffers, the differences between the types of commands of the first quantum computing task and the second quantum computing task can be leveraged to allow for a larger number of commands of the second quantum computing task to be loaded during execution of the first quantum computing task.

In some embodiments of the above-described method, the loading comprises loading of one or more partial buffers. The loading of one or more partial buffers allows for better usage of available memory buffers that store commands for the first quantum computing task but still have available space can be utilized to store commands for the second quantum computing task.

In some embodiments of the above-described method, the method further comprises preventing, by the system, in-use buffer data for the first quantum computing task from being overwritten during loading of commands for the second quantum computing task. This ensures that the loading of commands for the second quantum computing task during execution of the first quantum computing task does not interfere with execution of the first quantum computing task.

In some embodiments of the above-described method, the method further comprises executing, by the system, commands for the second quantum computing task, wherein the second quantum computing task is executed using the quantum state produced by the first quantum computing task. By loading commands for the second quantum computing task during execution of the first quantum computing task and then executing the second quantum computing task using the state produced by the first quantum computing task, the quantum state produced by the first quantum computing task can be utilized before quantum decoherence can impact the accuracy of the quantum state.

According to an embodiment of the invention, a computer program product comprises a computer readable storage medium having program instructions embodied therewith, the program instructions executable by a processor to cause the processor to execute, by the processor, commands for a first quantum computing task in a quantum computer, identify, by the processor, commands shared between the first quantum computing task and a second quantum computing task, prevent by the processor, redundant loading of the commands shared between the first quantum computing task and the second quantum computing task, and load, by the processor, during execution of the first quantum computing task, commands for the second quantum computing task that are not shared by the first quantum computing task into control electronics of the quantum computer. An advantage of such a computer implemented method is that by loading commands for a second quantum computing task during execution of the first quantum computing task, the amount of downtime between execution of sequential quantum computing tasks is decreased, thereby allowing more tasks to be executed in a defined timeframe. By allowing more tasks to be executed in a defined timeframe, additional calibration tasks can be performed to ensure that the quantum computer to properly calibrated, thereby improving fidelity of results of executed quantum computing tasks.

In some embodiments of the above-described computer program product, the program instructions executable by the processor further causes the processor to manage, by the processor a reference of data for quantum computing tasks. By managing a reference of data for quantum computing tasks, buffer locations where commands are loaded can be tracked, allowing for better utilization of the memory buffers.

In some embodiments of the above-described computer program product, the reference of data for quantum computing tasks comprises a sequence of buffered quantum computing tasks for loading while a preceding quantum computing task in the sequence of buffered quantum computing tasks is executed. By managing a sequence of buffered quantum computing tasks, the commands for one or more additional quantum computing tasks can be preloaded during execution of a first quantum computing task, thereby decreasing the downtime between execution of sequential quantum computing tasks.

In some embodiments of the above-described computer program product, the loading comprises loading of one or more individual buffers. By loading one or more individual buffers, the differences between the types of commands of the first quantum computing task and the second quantum computing task can be leveraged to allow for a larger number of commands of the second quantum computing task to be loaded during execution of the first quantum computing task.

In some embodiments of the above-described computer program product, the loading comprises loading of one or more partial buffers. The loading of one or more partial buffers allows for better usage of available memory buffers that store commands for the first quantum computing task but still have available space can be utilized to store commands for the second quantum computing task.

In some embodiments of the above-described computer program product the program instructions executable by the processor further causes the processor to execute, by the processor, commands for the second quantum computing task, wherein the second quantum computing task is executed using the quantum state produced by the first quantum computing task. By loading commands for the second quantum computing task during execution of the first quantum computing task and then executing the second quantum computing task using the state produced by the first quantum computing task, the quantum state produced by the first quantum computing task can be utilized before quantum decoherence can impact the accuracy of the quantum state.

The invention is directed towards decreasing the downtime of quantum computers between ending execution of a first quantum computing task and beginning execution of a second quantum computing task. By decreasing the downtime between execution of quantum computing tasks, more quantum computing tasks can be completed in a given timeframe, thereby increasing efficiency of use of the quantum computer. Further, this allows for more calibration tasks to be performed, thereby increasing the fidelity of results produced by the quantum computer.

Due to the complexity of quantum computers, there is a desire to maximize the number of quantum computing tasks that a quantum computer can execute in a given time frame. When executing a quantum computing task, a large time bottleneck is the loading time required to configure system settings and load program memory in order to execute a quantum job. For example, due to the nature of operations of quantum computers, multiple types of memory loads are required to execute a job such as instruction memory, scratch memory, waveform memory and others. These loads are responsible for a large overhead and prevent quantum systems from operating at the highest fidelity. For example, due to the load constraints, entities operating quantum computers are forced to decide between running a higher number of calibration tasks to maintain high fidelity of results and thus limit the number of other tasks that can be executed, or limit the number of calibration tasks, thereby lowering fidelity of results but allowing for a larger number of other tasks to be executed. Furthermore, due to the long memory load times, additional quantum computing tasks often cannot be performed on the results of a quantum computing task as the decoherence of results will occur while loading for the additional tasks takes place.

In view of the problems discussed above, in relation to quantum computing task loading, the present disclosure can be implemented to produce a solution to one or more of these problems by executing commands for a first quantum computing task in a quantum computer, identifying commands shared between the first quantum computing task and a second quantum computing task, preventing redundant loading of the commands shared between the first quantum computing task and the second quantum computing task, and loading, during execution of the first quantum computing task, commands for the second quantum computing task that are not shared by the first quantum computing task into control electronics of the quantum computer. By loading commands for a second quantum computing task during execution of a first quantum computing task, the amount of downtime between execution of quantum computing tasks is decreased. Furthermore, by preventing redundant loading of shared commands between the quantum computing tasks, the total number of commands that are loaded are decreased, and the amount of the commands that can be loaded during execution of previous jobs is increased. This overall decrease in downtime can enable more quantum computing tasks to be executed in the same time period and/or allow for quantum computing tasks to be executed on the results of previous quantum computing tasks.

In a further embodiment, the present disclosure can be implemented to load, during execution of a first quantum job, a portion of commands for a second quantum job into an individual buffer. Separate memory buffers are used for different portions of the control electronics of the quantum computer. Accordingly, the present disclosure can allow for load of one or more specific, individual buffers based on availability. For example, if there is space in the waveform generator buffer for commands for a second quantum computing task, the waveform generator commands can be loaded during execution of a first quantum computing task. In another embodiment, the present disclosure can be implemented to load, during execution of a first quantum computing task, one or more partial buffers with commands for a second quantum computing task. For example, if the waveform generator buffer lacks space for all the waveform generator commands due to the storage of commands for the first quantum computing task, some of the waveform generator commands for the second quantum computing task can be loaded using any space available in the waveform generator buffer, with additional commands being loaded as space becomes available in the waveform generator buffer.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

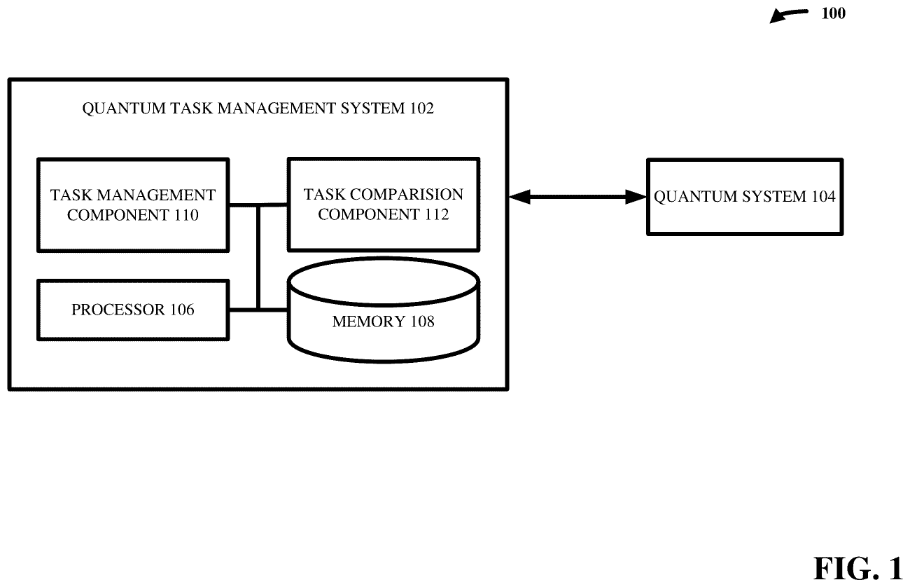

FIG. 1 illustrates a block diagram of an example, non-limiting system 102 that can facilitate preloading of quantum computing tasks in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise task management component 110, task comparison component 112, quantum system 104, processor 106 and memory 108.

In various embodiments, quantum computing task management system 102 can comprise a processor 106 (e.g., a computer processing unit, microprocessor) and a computer-readable memory 108 that is operably connected to processor 106. The memory 108 can store computer-executable instructions which, upon execution by the processor, can cause the processor 106 and/or other components of the quantum computing task management system 102 (e.g., task management component 110 and/or task comparison component 112) to perform one or more acts. In various embodiments, memory 108 can store computer-executable components (e.g., task management component 110 and/or task comparison component 112), and the processor 106 can execute the computer-executable components.

In one or more embodiments, task management component 110 can manage a reference of data for one or more quantum computing tasks. In one or more embodiments, the reference of data can be stored as a data table or in a circular data structure. The data for the one or more quantum computing tasks can comprise what order the quantum computing tasks are to be executed, the commands for each of the quantum computing tasks and/or other data related to preparation and execution of the quantum computing tasks. A quantum computing task refers to an entity defined quantum circuit that is executed on a quantum computer. During execution of a quantum computing task, control electronics and instruments of a quantum computer (such as a waveform generator) generate and send high-frequency electromagnetic waveforms to qubits within the quantum computer to manipulate the qubits and collect data based on the entity defined quantum circuit. In order to execute the quantum computing task, commands for the control electronics are loaded from the task management component 110 into various memory buffers associated with the control electronics of quantum system 104. These memory buffers can comprise instruction memory buffers, scratch memory buffers, waveform memory buffers and/or memory buffers related to any other operations of the control electronics of quantum system 104. While quantum systems often utilize multiple memory buffers of the same type (systems often comprise three buffers of each type), some tasks may utilize multiple buffers of the same type. For example, execution of some quantum computing tasks may utilize loading waveforms into two or three waveform buffers based on the number and complexity of waveforms needed.

Once the memory buffers are loaded, task management component 110 can track what commands for a quantum job are stored in which buffers and whether that command has been executed using an index for each quantum computing task. For example, task management component 110 can track that a waveform for a first quantum computing task is loaded into a second waveform memory buffer and whether the waveform has been used yet as part of the execution of the first quantum computing task. Once all commands for a quantum computing task have been loaded into an appropriate buffer, quantum system 104 can execute the quantum computing task.

In order to reduce downtime of the quantum system 104, task management component 110 can begin loading one or more commands for a second quantum computing task into the memory buffers of the control electronics during the execution of the first quantum computing task. In some embodiments this loading can comprise the loading of commands into specific individual buffers. For example, if waveforms for the first quantum computing task are loaded into the first and second waveform buffer, then waveforms for the second quantum computing task can be loaded into the third waveform buffer. In some embodiments, as commands are executed for the first quantum computing task, task management component 110 can mark the commands as executed in the index for the task and free up the buffer space associated with the executed command for loading of commands for the next quantum computing task. For example, after a first waveform command for a first quantum computing task is executed, task management component 110 can mark the waveform as executed and begin loading a waveform for the second quantum computing task into the buffer space that was occupied by the first waveform. In this manner, task management component 110 can dynamically preload commands for the second quantum computing task by loading commands as buffer space becomes available. Furthermore, by noting if commands have been executed or not, task management component 110 can prevent in-use or still to be used buffer data for the first quantum computing task from being overwritten as part of preloading commands for the next quantum computing task. In a further embodiment, task management component 110 can load one or more partial buffers with commands for a second quantum computing task during execution of a first quantum computing task.

In some cases, commands for a quantum computing task may use only part of a buffer. For example, the commands for a first quantum computing task may only utilize a portion of an instruction memory buffer, rather than the entirety of the buffer. In this case, task management component 110 can preload some or all of the instruction commands into the remaining space in the partially full instruction memory buffer. In the event that not all of the instruction commands for the second quantum computing task fit within the partial space of the instruction memory buffer, the rest of the instruction memory commands for the second quantum computing task can be store in other available instruction memory buffers or loaded as instruction memory buffer space becomes available during execution of the first quantum computing task. In this manner, task management component 110 can better utilize the limited available buffer space in order to decrease downtime between quantum computing tasks.

In one or more embodiments, task comparison component 112 can identify commands shared between a first quantum computing task and a second quantum computing task. In some cases, many commands will be shared between multiple quantum computing tasks. For example, commands related to the collection of data from specific qubits may be the same across multiple quantum computing tasks. In another example, portions of the quantum circuits for multiple quantum computing tasks may be identical across multiple quantum computing tasks, and thus the commands are shared across those multiple quantum computing tasks. In a further example, a waveform used in execution of a first quantum computing task may be the same as a waveform used in execution of a second quantum computing task. Accordingly, multiple commands may be shared between sequential quantum computing tasks, leading to the commands being loaded multiple times. In order to prevent these multiple loads and decrease overall loading times, task comparison component 112 can identify commands for a second quantum computing task that are currently loaded in order to execute the first quantum computing task. For example, if a waveform command is shared between the first quantum computing task and the second quantum computing task, task comparison component 112 can notify task management component 110 of the shared waveform command. Rather than loading the shared waveform command a second time, task management component 110 can mark the waveform command as loaded for execution of the second quantum computing task and note the buffer it is stored in, in the index of commands for the second quantum computing task, to allow for execution of the second quantum computing task.

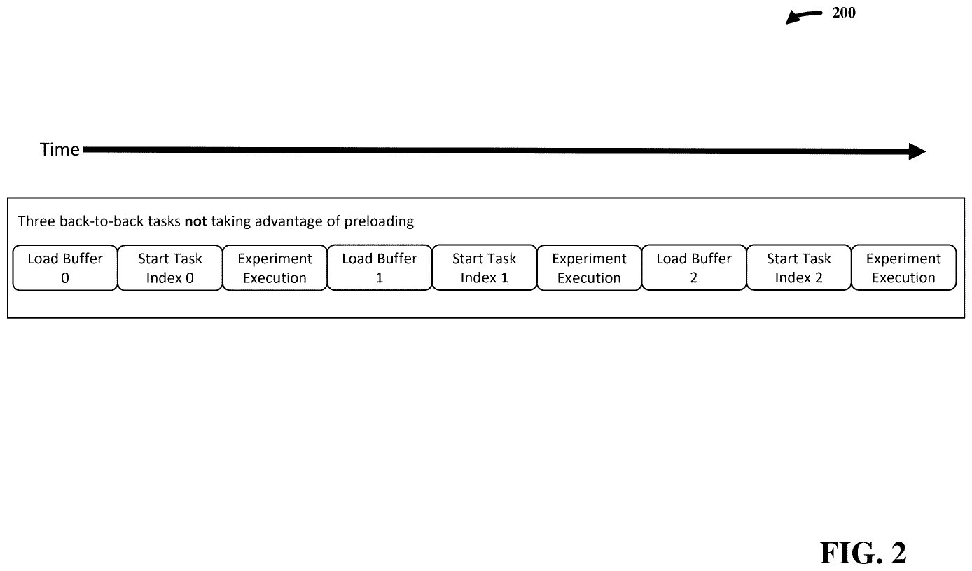

FIG. 2 illustrates an example of execution of a sequence of quantum computing tasks without preloading. As shown in FIG. 2, without preloading, the loading of buffer 1 for execution of task 1 does not occur until after completion of the execution of task 0. Similarly, the loading of buffer 2 for execution of task 2 does not occur until after completion of the execution of task 1. Accordingly, the quantum computer is inoperable for the entirety of the load times for buffers 1 and 2. This delay decreases the overall number of quantum jobs that can be executed in a given timeframe. Additionally, this delay means that additional tasks cannot be executed using the results of previous tasks due to information loss from quantum decoherence.

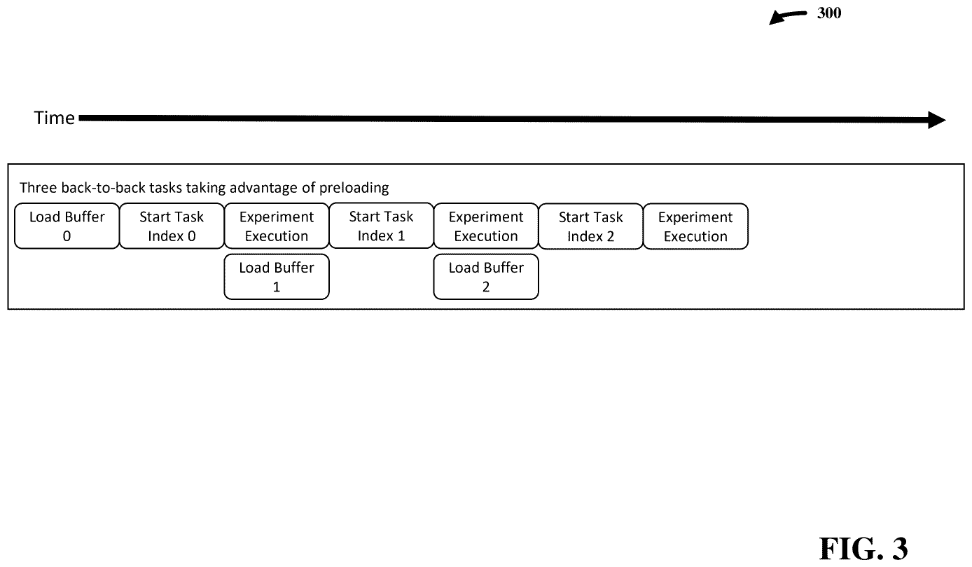

FIG. 3 illustrates an example of execution of a sequence of quantum computing tasks with preloading in accordance with one or more embodiments described herein. As shown in FIG. 3, buffer 1 can be loaded with commands for task 1 during the execution of task 0. In this manner, task 1 can be started immediately after task 0, thereby preventing downtime between execution of experiments. In some embodiments, task 1 can be performed on the results of task 0 due to the lack of downtime between experiments. Similarly, buffer 2 can be loaded for task 2 during the execution of task 1. In this manner, the preloading as described herein can allow more quantum computing tasks to be executed over a defined time period in comparison to methods without preloading. Further, the preloading as described herein can allow for the chaining of multiple tasks that are executed using the results of previous tasks. For example, task 1 can be executed using the results of task 0 and task 2 can be executed using the results of task 1. This can allow for performance of sequential tasks using regression parameters (e.g., sequences wherein a task is repeated with one or more parameters being modified on each iteration) or iterations of the same task multiple times on the output of the previous iteration such as for or while loops.

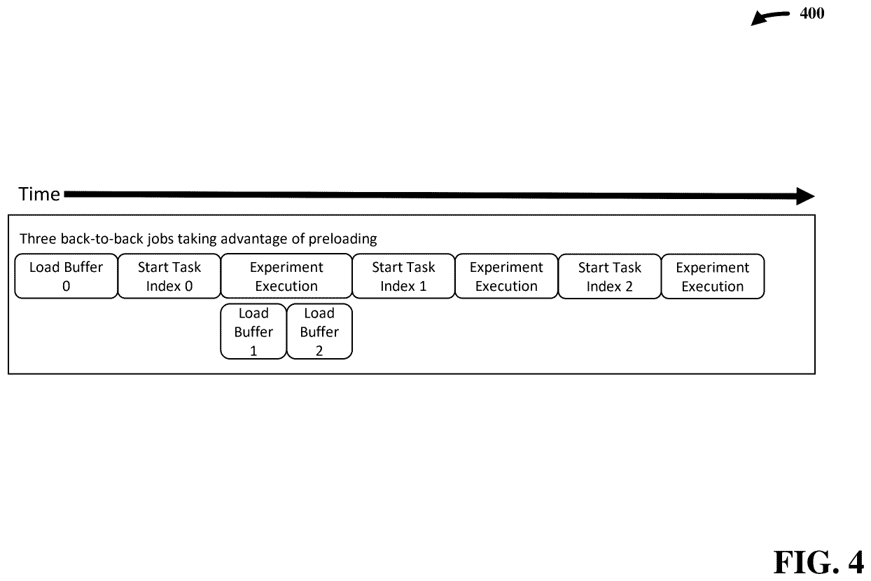

FIG. 4 illustrates an example of execution of a sequence of quantum computing tasks with preloading of multiple sequential tasks in accordance with one or more embodiments described herein. In some cases, execution of a first task may take long enough to allow for preloading of commands for multiple future tasks. As shown in FIG. 4, buffer 1 is loaded for task 1 and buffer 2 is loaded for task 2 during execution of task 0. As described above in relation to FIG. 1, task comparison component 112 can compare commands between tasks to prevent redundant loading of shared commands. In the case illustrated by FIG. 4, task comparison component 112 can compare the commands of task 0, task 1 and task 2 to identify commands shared between two or more of the tasks. Task management component 110 can then utilize the identified shared commands to reduce the overall number of commands that are loaded into the buffers, thereby decreasing load times and the number of load operations.

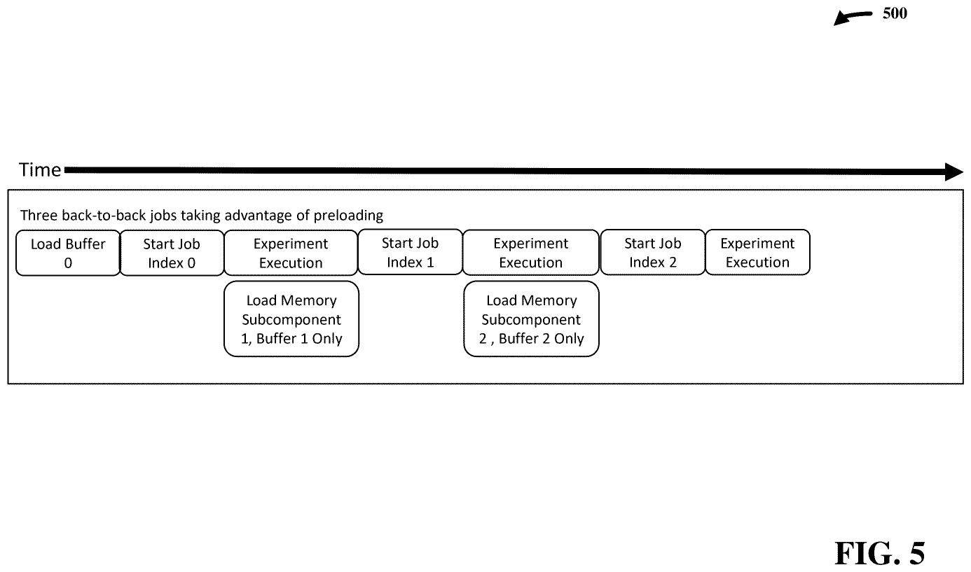

FIG. 5 illustrates an example of execution of a sequence of quantum computing tasks with preloading of specific individual buffers in accordance with one or more embodiments described herein. As described above in relation to FIG. 1, task management component 110 can load specific individual buffers associated with specific control electronics of a quantum system. For example, as shown in FIG. 5, during execution of task 0 Memory Subcomponent 1 buffer 1 is loaded for task 1. In some embodiments, the specific individual buffer is preloaded when the other commands utilized to execute the task have already been loaded to execute a previous task. Similarly, during execution of task 1, Memory Subcomponent 2 buffer 2 is loaded for task 2.

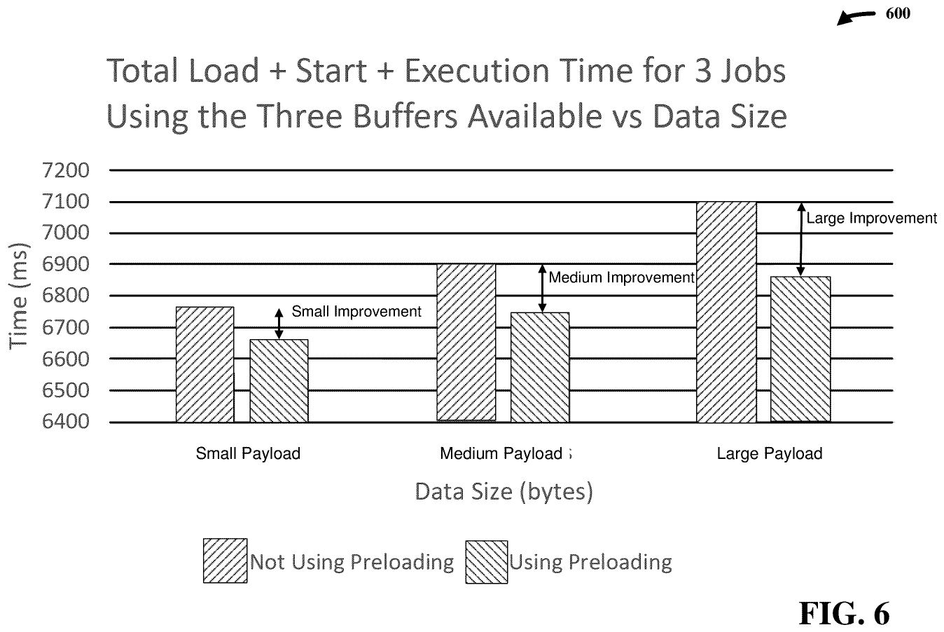

FIG. 6 illustrates a graph 600 comparing the execution time of quantum systems with and without preloading of future quantum computing tasks in accordance with one or more embodiments described herein. Graph 600 shows a comparison of the time to complete sets of three quantum computing tasks and the total data size of the commands used to execute the three quantum computing tasks. For three tasks that comprise a small size payload, the time to execute the three tasks using preloading as described herein is decreased by a small amount in comparison to execution of the same payload without preloading. For three tasks that comprise a medium size payload, the time to execute the three quantum computing tasks using preloading as described herein is decreased by a moderate amount in comparison to execution of the same payload without preloading. For three tasks that comprise a large size payload, the time to execute the three quantum computing tasks using preloading as described herein is decreased by a large amount in comparison to execution of the same payload without preloading. These decreases in time can enable more quantum computing tasks to be performed within a time frame, allowing for better utilization of the quantum system and/or the execution of more calibration tasks, thereby improving the fidelity of results of other quantum computing tasks.

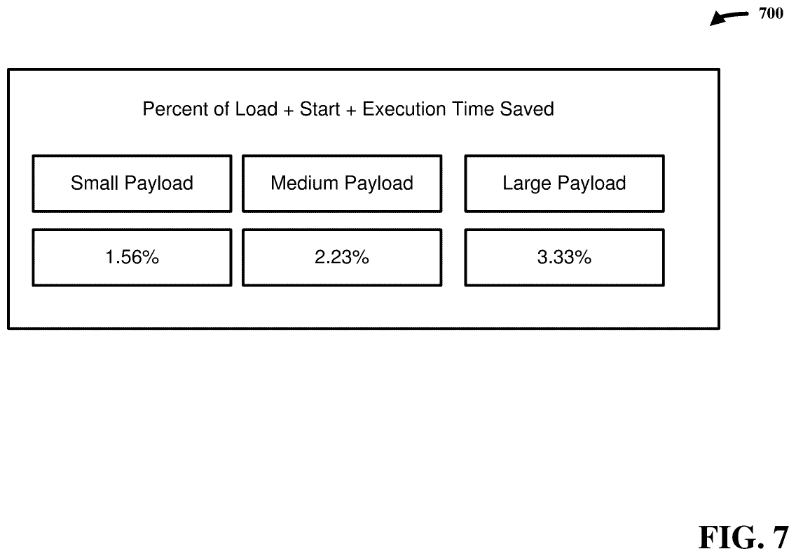

FIG. 7 illustrates a chart 700 showing the percentage of time saved during execution when employing preloading in accordance with one or more embodiments described herein. Chart 700 illustrates a percentage decrease in execution times of the three examples illustrated in FIG. 6. As shown in the small payload example, preloading as described herein provides a 1.56% decrease in overall execution time. In the medium payload example, preloading as described herein provides a 2.23% decrease in overall execution time. In the large payload example, preloading as described herein provides a 3.33% decrease in overall execution time. It should be appreciated that as the overall storage size of the commands utilized to execute quantum computing tasks increases, the percentage decrease in execution time increased. Accordingly, as the complexity of quantum computing tasks and the number of quantum computing tasks that are sequentially performed increase, the benefits of preloading as described herein will also increase.

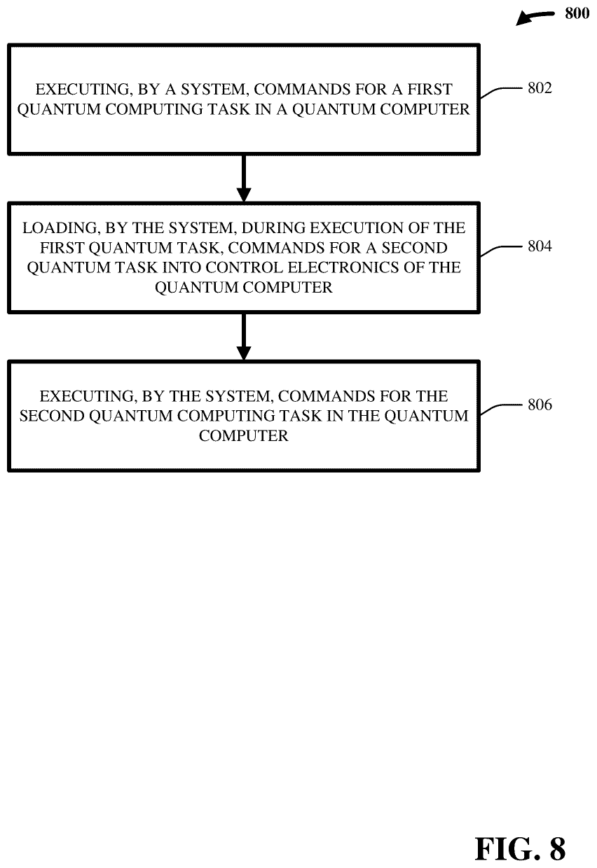

FIG. 8 illustrates a flow diagram of an example, non-limiting, computer implemented method 800 that facilitates preloading of commands for a quantum computing task in accordance with one or more embodiments described herein. Repetitive description of like elements employed in other embodiments described herein is omitted for sake of brevity.

At 802, method 800 can comprise executing by a system (e.g., quantum computing task management system 102) operatively coupled to a processor (e.g., processor 106), a first quantum computing task in a quantum computer (e.g., quantum system 104). As described above in relation to FIG. 1, quantum computing tasks can be executed through the use of a list of commands loaded into control electronics of quantum system 104, which manipulate the quantum processor and/or qubits within quantum system 104.

At 804, method 800 can comprise loading, by the system (e.g., quantum computing task management system 102 and/or task management component 110) during execution of the first quantum computing task, commands for a second quantum computing task into control electronics of the quantum computer. For example, as described above in relation to FIG. 1, the commands can be loaded into additional buffers available to the control electronics. In another example, some or all of the commands can be loaded into buffers that are partially occupied by commands for the first quantum computing task. In a further example, the commands can be loaded into specific individual buffers associated with specific portions of the control electronics of the quantum system.

At 806, method 800 can comprise executing, by the system (e.g., quantum computing task management system 102) the second quantum computing task in the quantum computer (e.g., quantum system 104). As the commands for the second quantum computing task were preloaded (e.g., loaded during execution of the first quantum computing task), there is a decreased time delay between finishing execution of the first quantum computing task and the beginning of execution of the second quantum computing task.

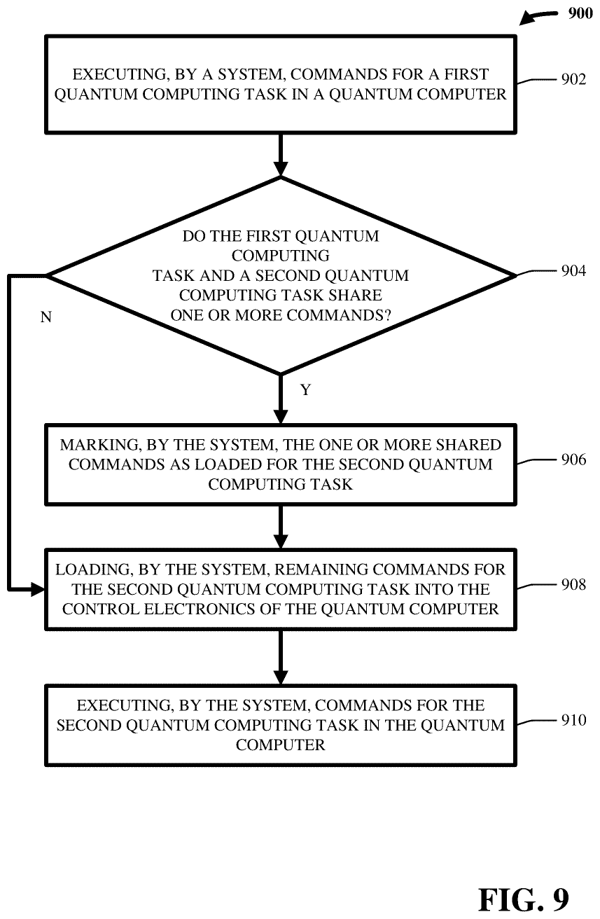

FIG. 9 illustrates a flow diagram of an example, non-limiting, computer implemented method 900 that facilitates preloading of commands for a quantum computing task and prevents redundant loading of commands in accordance with one or more embodiments described herein. Repetitive description of like elements employed in other embodiments described herein is omitted for sake of brevity.

At 902, method 900 can comprise executing by a system (e.g., quantum computing task management system 102) operatively coupled to a processor (e.g., processor 106), a first quantum computing task in a quantum computer (e.g., quantum system 104). As described above in relation to FIG. 1, quantum computing tasks can be executed through the use of a list of commands loaded into control electronics of quantum system 104, which manipulate the quantum processor and/or qubits within quantum system 104.

At 904, method 900 can comprise identifying, by the system (e.g., quantum computing task management system 102 and/or task comparison component 112) if the first quantum computing task and a second quantum computing task share one or more commands. In many cases, different quantum computing tasks can utilize one or more identical commands which can introduce cases of redundant loading. In response to a YES determination, method 900 can proceed to step 906. In response to a NO determination, method 900 can proceed to step 908.

At 906, method 900 can comprise marking, by the system (e.g., quantum computing task management system 102 and/or task management component 110) the one or more shared commands between the first quantum computing task and the second quantum computing task as loaded. For example, rather than re-loading the one or more shared commands between the two quantum computing tasks, task management component 110 can mark the one or more shared commands as loaded and add the buffer location of the one or more shared commands to the index of loaded commands for the second quantum computing task. By preventing redundant loading of shared commands, both the amount of time spent loading commands for the second task, and the workload of the memory and the buffers, are decreased.

At 908, method 900 can comprise loading, by the system (e.g., quantum computing task management system 102 and/or task management component 110) during execution of the first quantum computing task, remaining commands for the second quantum computing task into the control electronics of the quantum computer. For example, the commands of the second quantum computing task that are not shared by the first quantum computing task can be loaded into the buffers for the control electronics during execution of the first quantum computing task and the buffer locations can be noted in the index of loaded commands for the second quantum computing task.

At 910, method 900 can comprise executing by a system (e.g., quantum computing task management system 102) operatively coupled to a processor (e.g., processor 106), the second quantum computing task in the quantum computer (e.g., quantum system 104).

Quantum computing task management system 102 can provide technical improvements to classical and quantum hardware associated with quantum computing task management system 102. For example, preventing redundant loading of commands between one or more quantum computing tasks in a sequence of quantum computing task, the workload (e.g., the number of loading operations performed) of a memory unit associated with quantum computing task management system 102 is decreased as shared commands are loaded once, not multiple times. In another example, by preloading commands of a second quantum computing task during execution of a first quantum computing task, the overall time used to execute both quantum computing tasks is decreased. This additional time can be utilized to execute more calibration tasks on the quantum hardware, thus improving the fidelity of results when executing quantum computing tasks. By improving the fidelity of results, accurate quantum results can be achieved in fewer repetitions (alternatively referred to as shots) in comparison to other methods.

A practical application of quantum computing task management system 102 is that it allows for subsequent quantum computing tasks to be executed on the results of previously executed quantum computing tasks. For example, due to quantum decoherence, quantum computing tasks are difficult to execute on results of previous quantum computing tasks, as any delay between the ending of the first quantum computing task and beginning of execution of the second quantum computing task can cause a decay of the quantum state produced by the first quantum computing task, thus decreasing accuracy of any subsequent quantum computing task. By utilizing one or more of the preloading systems, methods and techniques described herein, the amount of time between finishing execution of a first quantum computing task and beginning execution of a second quantum computing task can be reduced and/or eliminated, thereby allowing execution of quantum computing tasks using results from a previously executed quantum computing task.

It is to be appreciated that quantum computing task management system 102 can utilize various combination of electrical components, mechanical components, and circuitry that cannot be replicated in the mind of a human or performed by a human as the various operations that can be executed by quantum computing task management system 102 and/or components thereof as described herein are operations that are greater than the capability of a human mind. For instance, the amount of data processed, the speed of processing such data, or the types of data processed by quantum computing task management system 102 over a certain period of time can be greater, faster, or different than the amount, speed, or data type that can be processed by a human mind over the same period of time. According to several embodiments, quantum computing task management system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum computing task management system 102 can include information that is impossible to obtain manually by an entity, such as a human user. For example, the type, amount, and/or variety of information included in quantum computing task management system 102 can be more complex than information obtained manually by an entity, such as a human user.

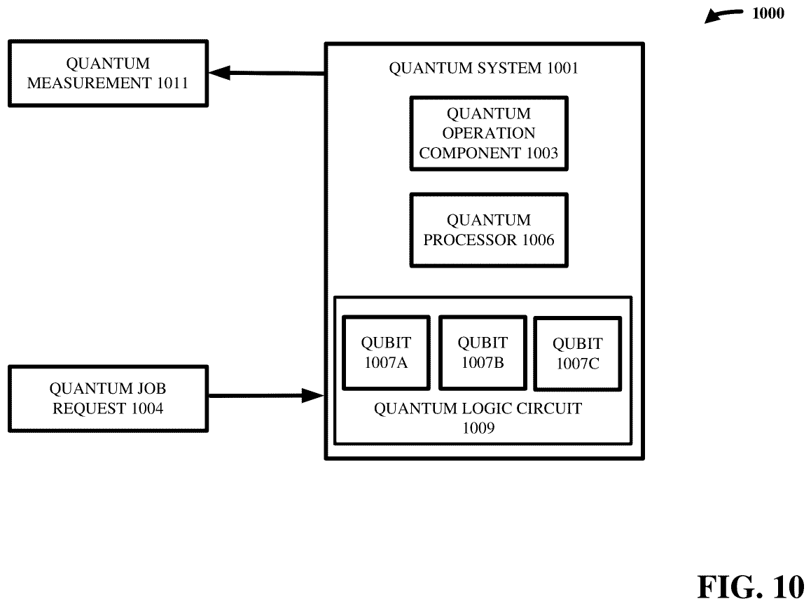

Turning generally to FIG. 10, one or more embodiments described herein can include one or more devices, systems and/or apparatuses that can facilitate executing one or more quantum operations to facilitate output of one or more quantum results. For example, FIG. 10 illustrates a block diagram of an example, non-limiting system 1000 that can complete the execution of a quantum job.

The quantum system 1001 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 1011, can be responsive to the quantum job request 1004 (e.g., a quantum computing task) and associated input data and can be based at least in part on the input data, quantum functions and/or quantum computations.

In one or more embodiments, the quantum system 1001 can comprise one or more quantum components, such as a quantum operation component 1003, a quantum processor 1006 and a quantum logic circuit 10010 comprising one or more qubits (e.g., qubits 1007A, 1007B and/or 1007C), also referred to herein as qubit devices 1007A, 1007B and 1007C. The quantum processor 1006 can be any suitable processor, capable of controlling qubit coherence and the like. The quantum processor 1006 can generate one or more instructions for controlling the one or more processes of the quantum operation component 1003.

The quantum operation component 1003 that can obtain (e.g., download, receive, search for and/or the like) a quantum job request 1004 requesting execution of one or more quantum programs. The quantum operation component 1003 can determine one or more quantum logic circuits, such as the quantum logic circuit 10010, for executing the quantum program. The request 1004 can be provided in any suitable format, such as a text format, binary format and/or another suitable format. In one or more embodiments, the request 1004 can be received by a component other than a component of the quantum system 1001, such as a by a component of a classical system coupled to and/or in communication with the quantum system 1001.

The quantum operation component 1003 can perform one or more quantum processes, calculations and/or measurements for operating one or more quantum circuits on the one or more qubits 1007A, 1007B and/or 1007C. For example, the quantum operation component 1003 can operate one or more qubit effectors, such as qubit oscillators, harmonic oscillators, pulse generators and/or the like to cause one or more pulses to stimulate and/or manipulate the state(s) of the one or more qubits 1007A, 1007B and/or 1007C comprised by the quantum system 1001. That is, the quantum operation component 1003, such as in combination with the quantum processor 1006, can execute operation of a quantum logic circuit on one or more qubits of the circuit (e.g., qubit 1007A, 1007B and/or 1007C). The quantum operation component 1003 can output one or more quantum job results, such as one or more quantum measurements 1011, in response to the quantum job request 1004.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 1000 can be a hybrid system and thus can include both one or more classical systems, such as a quantum program implementation system, and one or more quantum systems, such as the quantum system 1001. In one or more other embodiments, the quantum system 1001 can be separate from, but function in combination with, a classical system.

In such case, one or more communications between one or more components of the non-limiting quantum system 1000 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

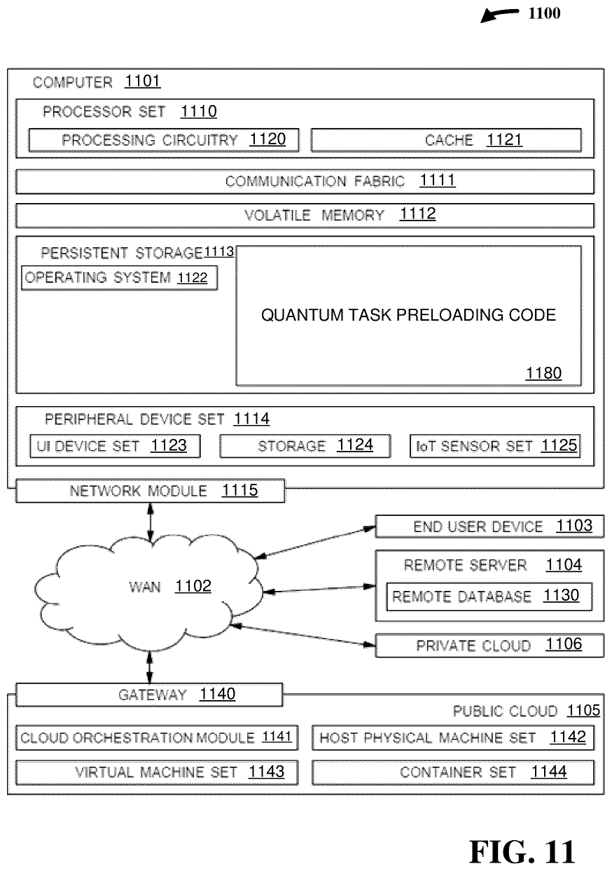

FIG. 11 and the following discussion are intended to provide a brief, general description of a suitable computing environment 1100 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the quantum computing task preloading code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1115 and private cloud 1116 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a quantum computer that executes commands for a first quantum computing task;
a memory that stores computer executable components; and
a processor that executes the computer executable components stored in the memory, wherein the computer executable components comprise:
a task comparison component that identifies one or more commands shared between the first quantum computing task and a second quantum computing task and prevents redundant loading of the one or more commands shared between the first quantum computing task and the second quantum computing task; and
a task management component that loads, during execution of the first quantum computing task, commands for the second quantum computing task that are not shared by the first quantum computing task into control electronics of the quantum computer.

2. The system of claim 1, wherein the task management component further manages a reference of data for quantum computing tasks.

3. The system of claim 2, wherein the reference of data for quantum computing tasks comprises a sequence of buffered quantum computing tasks for loading while a preceding quantum computing task in the sequence of buffered quantum computing tasks is executed.

4. The system of claim 1, wherein the loading comprises loading of one or more individual buffers.

5. The system of claim 1, wherein the loading comprises loading of one or more partial buffers.

6. The system of claim 1, wherein the task management component further prevents in-use buffer data for the first quantum computing task from being overwritten during loading of commands for the second quantum computing task.

7. The system of claim 1, wherein the quantum computer further executes commands for the second quantum computing task, wherein the second quantum computing task is executed using a quantum state produced by the first quantum computing task.

8. A computer-implemented method comprising:
executing, by a system operatively coupled to a processor, commands for a first quantum computing task in a quantum computer;
identifying, by the system, commands shared between the first quantum computing task and a second quantum computing task;
preventing, by the system, redundant loading of the commands shared between the first quantum computing task and the second quantum computing task; and
loading, by the system, during execution of the first quantum computing task, commands for the second quantum computing task that are not shared by the first quantum computing task into control electronics of the quantum computer.

9. The method of claim 8, further comprising managing, by the system, a reference of data for quantum computing tasks.

10. The method of claim 9, wherein the reference of data for quantum computing tasks comprises a sequence of buffered quantum computing tasks for loading while a preceding quantum computing task in the sequence of buffered quantum computing tasks is executed.

11. The method of claim 8, wherein the loading comprises loading of one or more individual buffers.

12. The method of claim 8, wherein the loading comprises loading of one or more partial buffers.

13. The method of claim 8, further comprising preventing, by the system, in-use buffer data for the first quantum computing task from being overwritten during loading of commands for the second quantum computing task.

14. The method of claim 8, further comprising executing, by the system, commands for the second quantum computing task, wherein the second quantum computing task is executed using a quantum state produced by the first quantum computing task.

15. A computer program product, comprising a computer readable storage medium having program instructions embodied therewith, the program instructions executable by a processor to cause the processor to:
execute, by the processor, commands for a first quantum computing task in a quantum computer;
identify, by the processor, commands shared between the first quantum computing task and a second quantum computing task;
prevent by the processor, redundant loading of the commands shared between the first quantum computing task and the second quantum computing task; and
load, by the processor, during execution of the first quantum computing task, commands for the second quantum computing task that are not shared by the first quantum computing task into control electronics of the quantum computer.

16. The computer program product of claim 15, wherein the program instructions executable by the processor further cause the processor to:
manage, by the processor a reference of data for quantum computing tasks.

17. The computer program product of claim 16, wherein the reference of data for quantum computing tasks comprises a sequence of buffered quantum computing tasks for loading while a preceding quantum computing task in the sequence of buffered quantum computing tasks is executed.

18. The computer program product of claim 15, wherein the loading comprises loading of one or more individual buffers.

19. The computer program product of claim 15, wherein the loading comprises loading of one or more partial buffers.

20. The computer program product of claim 15, wherein the program instructions executable by the processor further cause the processor to:
execute, by the processor, commands for the second quantum computing task, wherein the second quantum computing task is executed using a quantum state produced by the first quantum computing task.
